(19) United States
(12) Patent Application Publication
(10) Pub. No.: US 2017/0003665 A1
(43) Pub. Date: Jan. 5, 2017

(54) Remote Isolation System

(71) Applicant: Remsafe Pty Ltd, BALCATTA Western Australia (AU)

(72) Inventors: Michael Charles Lane, Dianella (AU); Kazimierz Kacperek, Ocean Reef (AU); Jack Mross, Fremantle (AU)

(21) Appl. No.: 15/199,732

(22) Filed: Jun. 30, 2016

(30) Foreign Application Priority Data
Jun. 30, 2015 (AU) 2015902558

(51) Int. Cl. G05B 9/02; B65G 43/00

(52) U.S. Cl. CPC G05B 9/02; B65G 43/00; G05B 2219/33204

(57) ABSTRACT

A remote isolation system (10) for a plant comprising a plurality of equipment items (20,21,21A,210,210A,250,250A) energisable by an energy source (30), a control system (50,260) enabling automatic isolation of each equipment item (20,21,21A,210,210A,250,250A) of said plurality of equipment items (20,21,21A,210,210A,250,250A) from said energy source (30) to an isolated state when authorised by the control system (50,260), wherein said control system (50,260) is configured to respond to an isolation demand input corresponding with one of a plurality of available equipment isolation modes, each of which enable automatic isolation of at least one of said plurality of equipment items (20,21,21A,210,210A,250,250A) from said energy source (30) when authorised by the control system (50,260).

This invention relates to a remote isolation system for isolating equipment. More specifically, the invention relates to an equipment isolation system where one of a number of isolation modes is able to be selected for isolating the equipment depending on specific circumstances.

Various types of equipment must be isolated from a range of energy sources including electrical energy (the most common) and mechanical energy including pressure and potential energy to enable safe maintenance and other work to be carried out. Conveyor belt systems used in the mining industry for transporting iron ore or other bulk materials which can span significant distances are one such example of equipment which may require to be isolated from time to time.

The distances such conveyor belt systems can span can be in the range of many kilometres. Such conveyors are typically powered by electric drive motors: three phase electrical power is supplied wherein the voltage may range from low voltage ranges (from below 600V to 1000V AC), to medium and high voltage ranges (in the multiple kV range and extending to above 10 kV AC and even 33 kV AC). Such conveyors typically include corresponding brake systems which are also electrically operated.

Although different mine procedures and relevant safety standards may apply, a typical pre-requisite before permitting mechanical maintenance or other activity involving access to the conveyor belt system involves the electrical isolation of the conveyor belt system. This isolation ensures that the energy source powering the conveyor belts and associated equipment, i.e. electrical power, is removed from systems or components that—if energised—could cause a safety hazard. It will however be understood that equipment items other than conveyor systems and other mining industry equipment also require isolation for maintenance and other purposes.

The isolation process is invariably safety critical and has, in the past, been time consuming, as described for example in the introduction to the Applicant's granted Australian Patent No. 2010310881 and International Publication No. WO 2012/142674, the contents of which are hereby incorporated herein by way of reference.

The remote isolation system described in Australian Patent No. 2010310881 enables equipment isolation to be requested at a remote isolation station associated with the equipment and subsequently approved through a plant control system, without mandatory visitation to the equipment by authorised isolation personnel. This remote isolation system significantly reduces the time required to achieve safe isolation, and more specifically the production downtime that would normally be involved with such an isolation which can be very costly.

A number of different plant operation and maintenance scenarios require equipment isolation to be done from time to time. In some instances, it may only be necessary to isolate a single equipment item or single system of a plant (such a system may for example include one or more, typically a plurality, of equipment items), according to a pre-determined isolation process, in order to effect the desired operation or maintenance task. Such isolation processes must typically be rigorously adhered to with potential disciplinary consequences for non-compliance.

Other scenarios are potentially much more complex in terms of a desired isolation being effected. For example, a material handling plant may involve a number of systems such as conveyor systems and other material handling equipment systems. On shutdown of the entire plant, it may be necessary to isolate these systems in a particular order. The Applicants remote isolation system, as described in Australian Patent No. 2010310881 and International Publication No. WO 2012/142674, provides significant advantages in accelerating the isolation process in such a scenario by pre-configuring an isolation process which shuts the plant down in the required order.

It is an object of the present invention to further develop a remote isolation system to be able to even more efficiently and expediently manage the various isolation scenarios that can occur in a material handling plant or indeed any plant where equipment requires isolation for certain purposes. Through doing so, plant availability and production may be improved.

With this object in view, the present invention provides a remote isolation system for a plant comprising:

a plurality of equipment items energisable by an energy source;

a control system enabling automatic isolation of each equipment item of said plurality of equipment items from said energy source to an isolated state when authorised by the control system,

wherein said control system is configured to respond to an isolation demand input corresponding with one of a plurality of available equipment isolation modes, each of which enable automatic isolation of at least one of said plurality of equipment items from said energy source when authorised by the control system.

The control system is conveniently configured to enable isolation of an equipment item on receiving an isolation demand input in the form of a permissible isolation request from an operator in a “standard” isolation mode. If the isolation request meets conditions (i.e. permissives) for isolation, automatic isolation is implemented. Such permissives may vary from plant to plant but would typically include a verified equipment fault where the remote isolation system is operating normally. This “standard” isolation mode would generally be included as an available equipment isolation mode.

The control system could also be configured to isolate an equipment item whilst leaving other equipment items either operating or in an operational state. That is, the isolation could exclude certain equipment items in an “exclusive” or “maintenance” isolation mode. Such an exclusive isolation mode may be used where maintenance or other tasks on a particular equipment item require other equipment to remain energised. Accordingly, the isolated and operational equipment items will typically form part of a particular system or unit within a plant. An example of such a system is a conveyor belt system in a material handling plant where a conveyor belt drive motor is isolated but the conveyor brakes require to remain energised to enable safe working conditions. In this case, the isolation demand input is also conveniently a permissible operator request. For certain applications, a dedicated control panel may be provided to implement exclusive control mode.

A “configurable” isolation mode may advantageously be applied to isolate a selected sub-set of equipment items from a set of equipment items which together comprise the plant or a plant system. In such a case, the isolation demand input, which may again be an operator-initiated isolation request, is provided by a selecting means for selecting a sub-set of equipment items for isolation. The selecting means may enable an operator to select a sub-set of equipment items to be isolated while leaving other equipment items operating. Alternatively, or additionally, the control system may select the sub-set of equipment items for isolation in an automated process depending on other commands input to the control system. The configurable isolation mode may also enable isolation of all equipment items in the plant for a maintenance shutdown. More commonly and particularly where sub-systems are duplicated or operate in parallel, maintenance can be conducted on a sub-set of equipment whilst operation of a further parallel sub-system of equipment items enables the plant to remain in a production state.

Another isolation mode suited to specific conditions may be one where a “conditional” isolation is effected whereby certain time benefits are realised because of the isolation taking place without requiring an operator request. For example, in such an isolation mode, the control system may automatically isolate an equipment item or system when a fault condition, typically a common fault condition such as tramp metal detection in a conveyor system, is detected by dedicated sensor(s). In such a scenario, the sensed fault condition is the isolation demand input for this case. An isolation lockout procedure as is known and required may then follow such a conditional isolation.

Following from this, the present invention also provides, in a further embodiment, a remote isolation system for a plant comprising:

at least one equipment item energisable by an energy source; and

a control system enabling automatic isolation of said equipment item of said plurality of equipment items from said energy source to an isolated state,

wherein said control system automatically isolates said at least one equipment item from said energy source when an equipment item operating condition as monitored by the control system requires equipment isolation.

Typically, the operating condition will be a fault detected through monitoring of an operating condition of the equipment item by appropriate sensors.

A further isolation mode which could be made available to the plurality of isolation modes is a “sequential” isolation mode in which associated equipment items are isolated in a specific sequence or order. As noted above, equipment items may be associated within plants in a variety of ways but, for present purposes, where safe working on one isolated equipment item also requires isolation of other equipment item(s), they are associated and a single isolation demand to include all the associated equipment items is the most efficient way of achieving safe isolation in an inclusive mode of isolation. The sequential isolation mode goes one step further and enables the associated equipment items to be isolated in a specific sequence, advantageously in response to a single isolation demand input such as a permissible operator initiated input.

Completion of isolation through a sequential mode of isolation may involve continuous monitoring of the equipment items, for example through the use of sensors, so that equipment is not flagged as isolated until monitoring confirms that this is the case. A range of sensors may also be used for this purpose dependent on the equipment involved and a plurality of different sensors is preferred to minimise hazard. In a conveyor system, proximity sensors and motion sensors may be appropriate. However, temperature and pressure sensors could be used, especially for monitoring a conveyor brake system. Sensors may of course be customised to the particular plant of interest. Such continuous monitoring is desirably provided for irrespective of the isolation mode and is not limited to sequential isolation.

A sequential mode of operation may also involve more than simply the order by which certain equipment is isolated. This mode of isolation may be particularly useful where for example energy, materials or other products may require purging, dumping, trapping, draining and/or charging with an inert gas, by way of example, before an isolation can take effect. Such events, or a specific subset thereof, may need to occur in a certain order for the isolation to be effective. An example of such a sequential isolation may be where a process line requires to be isolated, whereby the feed valve is required to close, the section of pipe is vented and then purged, and other isolation valves are actuated before an isolation is effected. In certain circumstances, such a sequential isolation may also require human intervention during some stages at hold points where the operation of some equipment can't be automated. This could equate for example to the manual operation of a valve.

The control system could also be configured with an isolation mode to isolate a plurality of associated equipment items by a single isolation demand input in the form of an operator request. Equipment items may be associated within plants in a variety of ways but, for present purposes, where safe working on one isolated equipment item also requires isolation of other equipment item(s), they are associated and a single isolation demand to include all the associated equipment items is the most efficient way of achieving a safe isolation in an “inclusive” mode of isolation. For example, one equipment item, such as a first conveyor belt, might be located downstream of another second conveyor belt which delivers material to the first conveyor. In such a case, first and second conveyor belts would be isolated together.

The remote isolation system advantageously includes one or a plurality of remote isolation stations for selected equipment to be isolated. Such remote isolation stations may be fixed in position. Mobile isolation devices may be used as remote isolation stations as described in the Applicant's Australian Provisional Patent Application Nos. 2015902561 and 2015902562 filed on 30 Jun. 2015, the contents of which are incorporated herein by way of reference.

Such remote isolation stations are in communication with the control system to enable isolation on permissible request. Such remote isolation stations are provided with control panels having input means, such as a human machine interface, for issuing an isolation demand input requesting a desired isolation mode option from the plurality of available isolation modes configured for the particular remote isolation system. The available isolation modes include at least two of the following: standard isolation mode, exclusive isolation mode, inclusive isolation mode, configurable isolation mode, conditional isolation mode and sequential isolation mode, each of which has been described above. The control panel advantageously integrates equipment isolation switch(es) for the selected equipment, a preferred equipment isolation switch being described in co-pending Australian Provisional Patent Application No. 2015902554 filed on 30 Jun. 2015, the contents of which are incorporated herein by way of reference.

Operator initiated isolation demand inputs in the form of requests may be made using a graphical user interface or through selection from a menu presented on a human/machine interface, such as a touch screen displaying desired menu options, at the remote isolation station control panels. The control panels may also or alternatively be provided with buttons or switches to request a desired isolation mode from the plurality of available isolation modes for selection.

The control panel could be configured to only enable remote isolation system operation following operator identity verification using operator identification devices integrated with the control panel or remote isolation system as described in the Applicant's Australian Provisional Patent Application Nos. 2015902559 and 2015902564 filed on 30 Jun. 2015, the contents of which are incorporated herein by way of reference. Such operator identification devices may receive operator identification data either directly and/or from an operator identification means. A range of operator identification devices and operator identification means could be used, the latter class conveniently including smart devices. For example, a smart card identification system could be implemented using a card reader located at the control panel.

Operator identification data would be stored in both the control system and any operator identification means, for example a smart card, following a conventional process and such data could include, or be tied to, isolation permits to select particular isolation modes and work in particular areas. Field validity checking is also possible. Other smart devices, such as smart phones, could be used to similar effect. This feature is particularly beneficial for ensuring that only operators authorised to work in particular areas or on certain equipment can request an available isolation mode and reduces risk of accidental or deliberate use of the remote isolation system. The control panel could display different isolation modes for different operators according to their operator identification data corresponding, for example, to isolation permits issued to them by the control system.

Where the equipment control system includes a plurality of control panels, isolation demand input means may also be made available at all or selected of those control panels. In one such arrangement, remote isolation stations including mobile isolation devices may be desirably used to significant benefit in a configurable isolation mode. Available equipment isolation modes can be configured or customised to specific control panels, such configuration being updated to cover particular operating conditions when required. It follows that each remote isolation station may be configured with either the same or a different plurality of isolation modes. Different operators may also be provided with the same or different plurality of isolation modes dependent on the authority given to them as reflected in operator identification data. The remote isolation system advantageously enables a wide range of isolation scenarios for the particular plant to be initiated from as little as one location significantly saving operator time and optimising plant production.

For avoidance of doubt, the remote isolation system is not required to include all of the above described isolation modes, though that may be highly desirable. In addition, the remote isolation system is not required to include a conditional isolation mode, though this may be a highly desirable feature for particular plants, such as material handling plants where tramp metal detection is a common occurrence and significant production time can be saved by employing conditional isolation (which as noted above may be used on a stand alone basis). The available isolation modes are, however, selected based on the requirements of particular plant operations and those of a commercial operator.

The remote isolation system may be retro-fitted to existing equipment and plants in a range of industries, for example the materials handling and mining industries. The remote isolation system may also advantageously be used for isolating rail system components in railway infrastructure as described in the Applicant's Provisional Patent Application No. 2015902560, the contents of which are incorporated herein by way of reference.

The term “isolation” as used in this specification is to be understood in its maintenance engineering and legal sense as not simply turning off a supply of energy to equipment, whatever the nature of that energy, but removing and/or dissipating energy to provide a safe work environment as required by applicable occupational health and safety regulations. In the case of electricity, as just one example, isolation is not achieved simply by turning off a power supply to the equipment. In such cases, the equipment could accidentally re-start or be restarted and cause injury to personnel, or worse. Isolation instead prevents such accidental re-starting and typically will also involve processes to dissipate any hazardous stored energy, in whatever form that energy may take (e.g. potential energy), from the equipment. For example, such an additional energy dissipation step could be effected in respect of a conveyor belt system by way of the braking cycle procedure as described in the Applicant's Australian Provisional Patent Application No. 2015902565, the contents of which are incorporated herein by way of reference.

The remote isolation system of the present invention may be more fully understood from the following description of preferred embodiments thereof made with reference to the accompanying drawings in which:

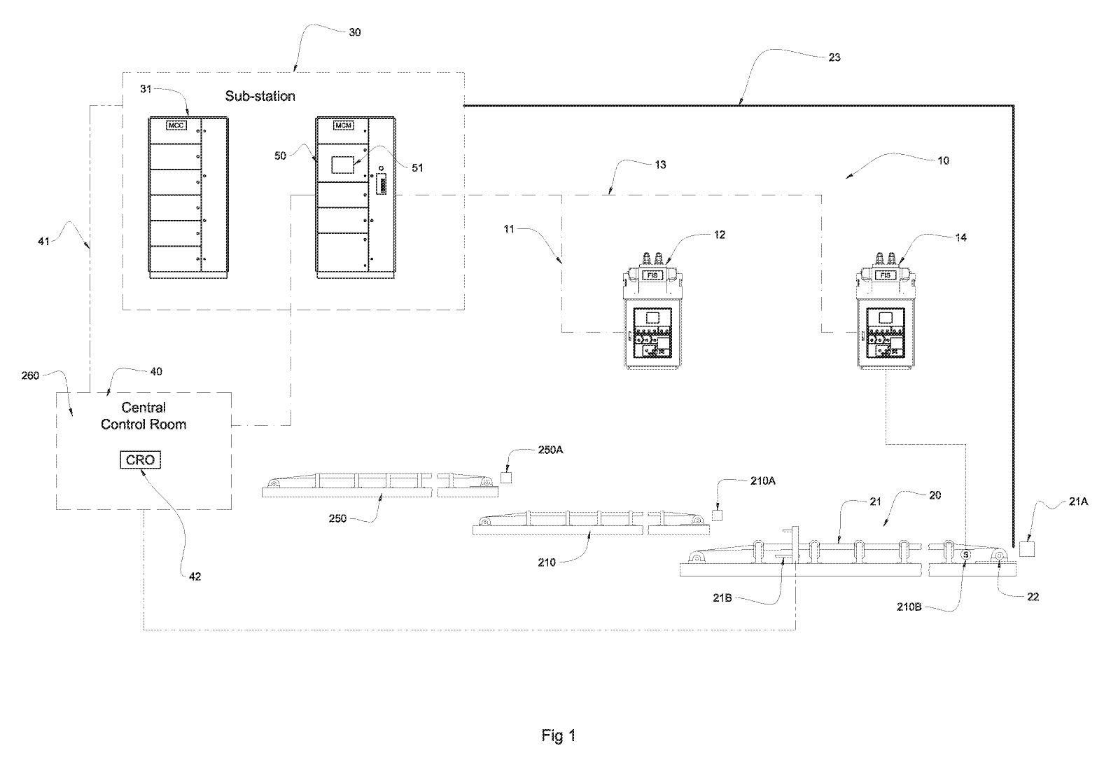

FIG. 1 shows a schematic layout of a remote isolation system as applied to a conveyor belt system and configured in accordance with one embodiment of the present invention.

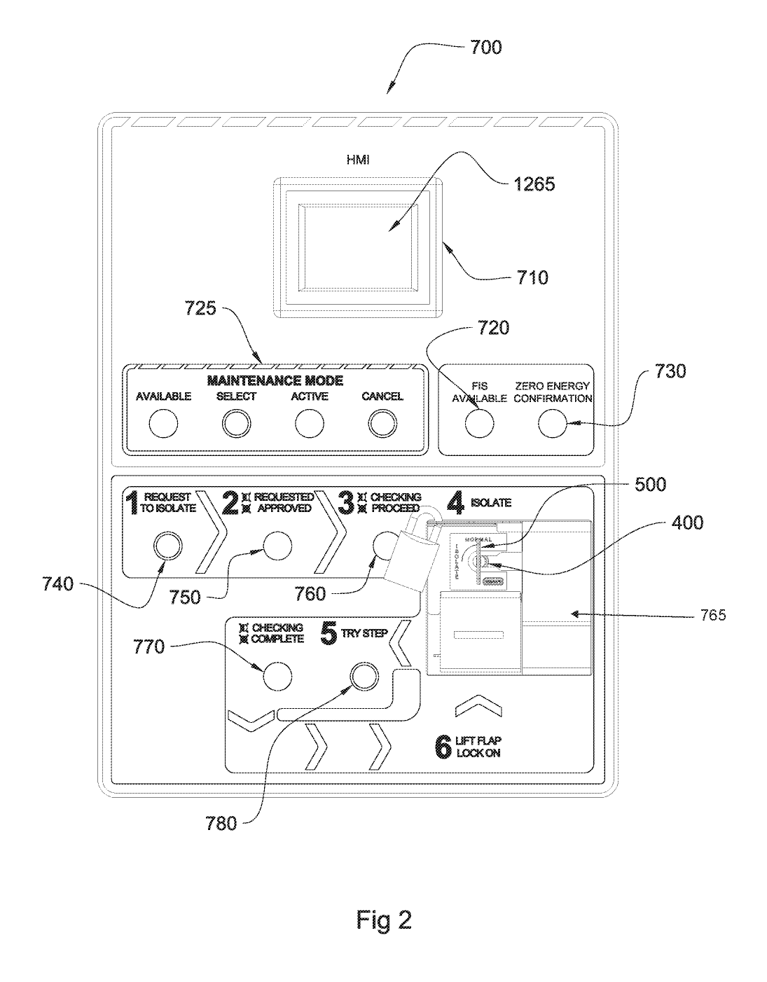

FIG. 2 shows a schematic of a control panel for use in the remote isolation systems schematised in FIG. 1.

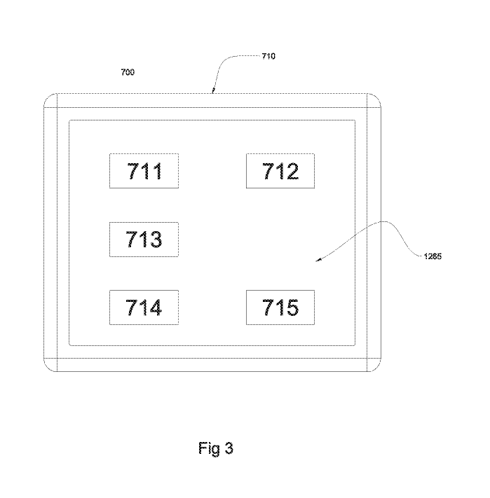

FIG. 3 shows a schematic of the screen of the control panel shown in FIG. 2 showing available isolation modes for the remote isolation system schematically shown in FIG. 1.

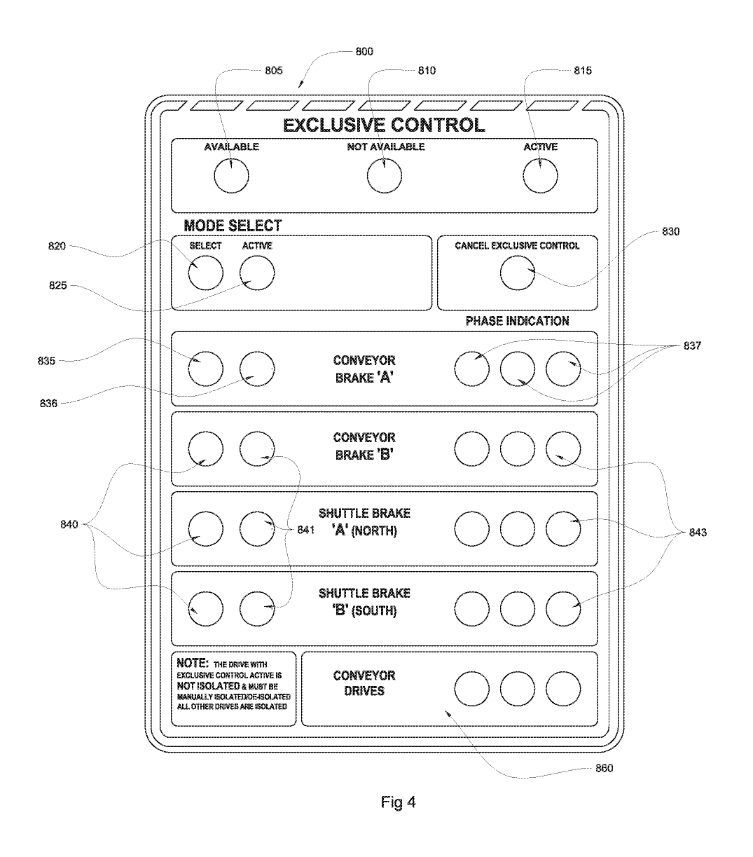

FIG. 4 shows a front view of a control panel of an exclusive control station used when operating the remote isolation system shown in FIG. 1 in exclusive control mode.

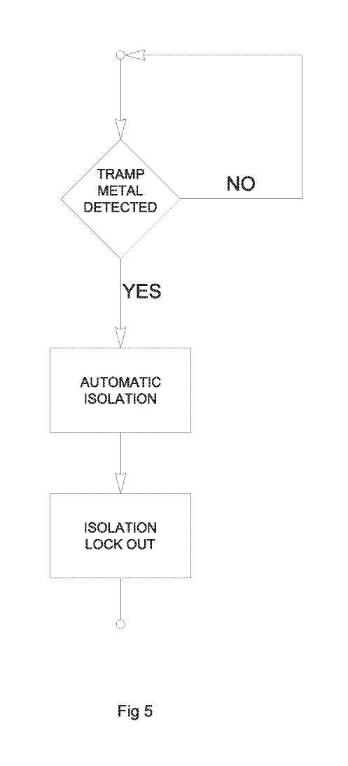

FIG. 5 shows a flowchart for operation of the remote isolation system of FIG. 1 in a conditional isolation mode.

Referring to FIG. 1, there is shown a schematic layout of a remote isolation system 10, as retrofitted to an existing conveyor belt system 20, for example a long range overland conveyor system for conveying iron ore from a mine site to a port for shipment. The conveyor belt system 20 comprises a troughed conveyor belt 21 having a head pulley motor 22 driven by an electrical supply emanating from electrical contacts 31, whether provided as contactors or circuit breakers. The head pulley motor 22 is powered through a variable speed drive (VSD) which is electrically powered from a three phase AC power supply line 23 providing voltages of less than 1000V AC.

Conveyor belt 21 is supplied with material from a further associated conveyor belt 210 driven by a head pulley motor having an electrical supply similar to that for conveyor 21 though with different electrical contacts (which are not shown for ease of understanding). Conveyor belts 21 and 210 are also provided with electrically powered braking systems 21A and 210A. Conveyor belt system 20 also includes a shuttle conveyor 250 which delivers material to conveyor belt 210 or another conveyor belt (not shown) when conveyor belt 21 is isolated. Shuttle conveyor 250 includes shuttle locking pins 250A for use in isolating conveyor 250 when required. A tramp metal detector 21B is also arranged for operation at the end of the conveyor belt 21 which is remote from the head pulley motor 22.

Electrical power for conveyor belt system 20 is supplied from a sub-station 30. The sub-station 30 houses the contacts 31. Activation of the contacts 31 (i.e. placing them in the “off” or “break” state), de-energises all three phases of the electrical supply to the conveyor head pulley drive motor 22. Such de-energisation is continuously monitored by a voltage monitor relay (not shown) located downstream of contacts 31, i.e. on the conveyor belt system 20 side of the contacts 31.

The conveyor belt system 20 and sub-station 30 are under the control and supervision of a plant control system 260 having a Central Control Room (CCR) 40, via a DCS (Distributed Control System), Programmable Logic Controller (PLC) and SCADA (Supervisory Control and Data Acquisition System) as are commonly used and would be well understood by the skilled person. Item 41 in FIG. 1 is representative of a communication and control network between the CCR 40 and various other plant systems and components. A Control Room Operator (CRO) 42 is located within the CCR 40 and has various input/output (I/O) devices and displays available (not shown) for the proper supervision and control of the conveyor belt system 20. Except for the remote isolation system 10, the above description represents what may be considered a conventional system as would be known within the materials handling and mining industries.

The remote isolation system 10 comprises fixed remote isolation stations 12 and 14 which are located proximate to the conveyor belt system 20. It will be understood that remote isolation stations 12 and 14 could be replaced or supplemented by one or more mobile isolation stations, for example in the form of mobile isolation devices such as portable computer devices (in certain applications these potentially being provided as smartphones) or communication devices using wireless communications, as disclosed for example in the Applicant's Provisional Patent Application Nos. 2015902561 and 2015902562 filed on 30 Jun. 2015, the contents of which are incorporated herein by way of reference. The remote isolation stations 12 and 14 may be powered from the plant grid, other power networks or alternative power sources, conveniently such as via solar power.

The remote isolation system 10 also includes a master controller 50 incorporating a human/machine interface (HMI) in the form of a touch sensitive screen 51 which displays human interpretable information. The master controller 50 is also located within sub-station 30. Remote isolation stations 12 and 14 are in communication with the master controller 50 and each other via communication channels 11 and 13. These communication channels can be provided in any suitable form including hard wired or wireless forms that satisfy known industrial open communication protocols with Ethernet communications being particularly preferred to enable flexible system updating. Communications are via safety rated communications protocol software, noting that these may be varied depending on the PLC platform used. For example, the Interbus Safety or PROFIsafe software solutions provide an indication of existing systems which are well known within the materials handling and mining industries. This will ensure that the communication channels are monitored and diagnostic tools are available for fault control and rectification when required.

Further description of the electrical layout and operation of the remote isolation system 10 is provided in the Applicants granted Australian Patent No. 2010310881, the contents of which are incorporated herein by way of reference.

FIG. 2 shows a schematic of a control panel 700 located at each of remote isolation stations 12 and 14 for implementing the Applicants remote isolation system 10. Panel 700 has a human machine interface (HMI) 710 with a touch screen 1265 (though less fragile buttons, switches and other input devices may be used in alternative arrangements) for entering isolation demand inputs in the form of operator initiated isolation requests and displaying isolation status and plant data. The control panel 700 also includes:
Indicator light 720 showing whether or not the remote isolation station (RIS) 12 or 14 is available for isolation;
Indicator light block 725 for indicating whether exclusive control or maintenance mode for the remote isolation system is active (exclusive control being where conveyor belt system 20 isolation is controlled exclusively from one remote isolation station (RIS) 12 as described further below) and respective “select” and “cancel” buttons for initiating or terminating the maintenance mode;
Indicator light 730 for indicating zero energy confirmation when dedicated sensors, for example including the above described voltage monitor relay and preferably conveyor belt 21 movement sensors as well, continuously monitoring isolation status both prior to and during isolation, indicate that zero hazardous energy is present in the conveyor belt system 20 (i.e. a zero energy indication is achieved when the culmination of all energy sources being monitored confirms that there is no stored or latent energy (whether potential, or electrical etc) remaining in the system desired to be isolated);
Request to isolate button 740 which is activated by an operator (and which illuminates when pressed) to request isolation;
Request approved indicator light 750 which illuminates to provide status information to said operator;
Indicator light block 760 for indicating that control system checking is taking place subsequent to an isolation request being instigated;
Indicator light block 770 for showing whether or not the isolation process is complete following control system checking;
Try step button 780 for requesting a try step in which a restart of the conveyor belt system 20 is attempted; and
Graphics (in the form of arrows and text) illustrating the sequence of steps to be followed in the required isolation procedure.

An equipment isolation switch box 765 comprising isolation switch 400 is also included on the control panel 700 and prevents regulated isolation by locking with an operator's padlock or hasp until the correct remote isolation procedure, for example as described in the Applicant's granted Australian Patent 2010310881, or Australian Provisional Patent Application No. 2015902554, has been completed.

HMI 710 of control panel 700 enables the operator to select one of a plurality of available isolation modes provided for remote isolation system 10, each of which enable automatic isolation of components within the conveyor belt system 20 from said energy source when authorised by the control system.

The plurality of available isolation modes for the operator to select from when needing to isolate one or more specific components of the conveyor belt system 20 include the following options:
1) Standard isolation mode;
2) Exclusive or maintenance isolation mode;
3) Configurable isolation mode.
4) Conditional isolation mode;
5) Sequential isolation mode; and
6) Inclusive isolation mode;

Each of these possible isolation modes will be described in further detail below with reference to FIGS. 2 to 5.

### Standard Isolation Mode

In a standard isolation mode, the conveyor belt system 20 is isolated by a procedure involving:
1) An operator request by pressing button 711 on screen 1265 of HMI 710 of remote isolation station 12 for control system 260 to then approve isolation of all or part of the conveyor belt system 20 including conveyor belt 21 and drive motor 22;
2) Isolation is approved if the operator request meets permissives for isolation, for example as described in Australian Patent No. 2010310881;
3) Isolation is then automatically implemented by the control system 260;
4) A try start step being invoked to check that isolation is effective, which involves checking that electrical contacts 31 for the conveyor belt system 20 are in isolated position with no voltage downstream of electrical contacts 31 as continuously monitored by the above described voltage monitor relay (and desirably conveyor belt 21 movement sensors as well); an attempt to re-start the conveyor belt system 20 using try step button 780 or an automated process; and checking that there is no re-energisation of conveyor belt system 20 (which may involve continuous monitoring as described in the Applicant's Australian Provisional Patent Application No. 2015902556 filed on 30 Jun. 2015, the contents of which are incorporated herein by way of reference); and
5) Subsequent lockout at the control panel of the remote isolation station 12 and/or 14 provided the try start is unsuccessful (as required).

As alluded to above, the remote isolation procedure requires a try start step to be effected by an operator pressing try step button 780 of the control panel 700 (as shown in FIG. 2) before any manual lock out is possible. The associated equipment isolation switch 765 is designed to prevent manual lock out before the isolation procedure is completed.

Equipment isolation switch box 765 includes an equipment isolation switch 400 movable by turning a key 500 between a first “NORMAL” position in which the drive motor 22 for the conveyor belt 21 is electrically energised and a second “ISOLATE” position in which the drive motor 22 is without power (i.e. de-energised), hence enabling maintenance works to be safely undertaken. However, turning key 500 from the NORMAL to ISOLATE positions is necessary but alone not sufficient for the remote isolation system 10 to properly isolate the conveyor belt 21 and its drive motor 22. The isolation switch 400 must be locked out, in this case by a manual lock out procedure using a hasp and personal lock. It will be understood that conveyor belts 210 and/or 250 would need to be isolated using a similar procedure though at different remote isolation stations (not shown) unless a configurable isolation mode is selected by the operator. Further description of this option will be provided hereinafter.

Selection of the “standard” isolation mode has particular applicability for example where all drives and energy sources require to be isolated so that tasks may then be done on the plant without having to wait for specialised personnel to isolate specific components. The “standard” isolation mode will also typically be one of the isolation mode options provided in an isolation system where a plurality of isolation modes are available for selection by an operator, irrespective of which other isolation modes are supported by the isolation system.

### Exclusive Isolation Mode

In an exclusive or maintenance isolation mode, the conveyor belt 21 is intended to be isolated by de-energising the head pulley drive motor 22 whilst the braking system 21A is left energisable for maintenance, shutdown tasks and testing purposes.

The exclusive isolation mode is initiated by the operator pressing button 712 on screen 1265 of HMI 710 of remote isolation station 12 for control system 260 to then approve isolation without isolation of conveyor braking system 21A which remains operative for use in maintenance, shutdown tasks and testing purposes. Conveyor belt 21 is isolated and locked out with a hasp and personal lock in essentially the same manner as for the aforementioned standard isolation mode.

This exclusive isolation mode is available for selection provided none of the remote isolation stations 12 and 14 are currently in use.

FIG. 4 shows a front view of a control panel 800 for an Exclusive Control Station (ECS) which may conveniently be mounted adjacent to the remote isolation station 12. The control panel 800 of the ECS is configured to facilitate the exclusive isolation mode initiated by the operator and which could relate to conveyor brake A (braking system 21A) and other plant conveyor braking systems (conveyor brake ‘B’, shuttle brake ‘A’ and shuttle brake ‘B’). For ease of illustration, it is supposed that braking system 21A is not to be isolated and the other noted braking systems are isolated).

Features of the control panel 800 include the following:
Indicator lights 805 and 810 indicating whether the control panel 800 is available for use;
Indicator light 815 indicating whether exclusive control is active;
Exclusive control mode selection buttons 820 and 825 allowing full isolation or selective isolation of the conveyor braking systems including braking system 21A and an indicator light marked “active” which illuminates if no isolation is in place;
Exclusive control cancellation button 830;
Exclusive control mode select button 835 (for braking system 21A) and select buttons 840 for the remaining conveyor braking systems;
Active indicator light 836 which illuminates if normal operation (“no isolation”) of braking system 21A is selected by pressing button 835 and whereby indicator lights 841 illuminate if normal operation of the other braking systems is selected by pressing any or all of select buttons 840;
Indicator lights 837 which show whether each phase of the electric power supply to braking system 21A is active or not and whereby indicator lights 843 show whether each phase of the electric power supply to the other braking systems mentioned above is active or not; and
Indicator light block 860 which shows whether each phase of the electric power supply to head pulley drive motor 22 is active or not.

Operation of the ECS control panel 800 is now described. The operator observes isolation of conveyor braking systems other than braking system 21A. Indicator lights 841 and 843 are not illuminated and operation of those conveyor braking systems is not required. The operator also observes, through no illumination of phase indicator lights in indicator light block 860, that the conveyor head pulley drive motor 22 has no power supply having been isolated according to the above isolation procedure.

The operator presses select button 835 enabling normal operation of conveyor brake A (braking system 21A). The active indicator light 836 illuminates and braking system 21A can be used as required during the maintenance of conveyor belt system 20.

Typically all remote isolation stations, including remote isolation station 14, are disabled for use during exclusive control, except the remote isolation station 12 located adjacent to the ECS control panel 800.

This provides an operator with exclusive control to start or stop the plant with specific components isolated via the control panel 800 (which acts as a local select/de-select system excluded from isolation by remote isolation system 10) and to isolate and de-isolate conveyor brake A (braking system 21A) as required to carry out tasks without the interference of other personnel. This lack of interference is assumed as other personnel cannot isolate and place personal isolation locks on the equipment isolation switch 400 of remote isolation station 12. Whilst this embodiment describes use of an exclusive isolation mode which is effected by way of a separate ECS control panel 800, it is of course possible in other arrangements for the control selection for exclusive isolation mode to be built into and managed by the remote isolation station 12 itself with no need for such a separate or additional ECS control panel 800.

### Configurable Isolation Mode

In a configurable isolation mode, the control system 260 may allow for a number of options for isolating a selected sub-set of equipment items from a set of equipment items which together comprise the conveyor belt system 20 which in turn forms part of a material handling plant including conveyor belts 21, 210 and 250 as well as the respective conveyor belt braking systems 21A and 210A and shuttle locking pins 250A. Each of these elements are shown schematically in FIG. 1, noting that operation of shuttle locking pins 250A may proceed in line with the Applicants Australian Provisional Patent Application No. 2015902566 filed on 30 Jun. 2015, the contents of which are incorporated herein by way of reference. Other components are of course also included within conveyor belt system 20 but do not require detailed description for the present purposes.

In this case, the configurable isolation demand input is again an operator-initiated isolation request initiated by pressing button 715 on screen 1265 of HMI 710 as shown in FIG. 3. On pressing button 715, a further suite of configuration options is displayed on the screen 1265, each of which is selectable by use of a selecting means involving pressing a button corresponding to the desired isolation configuration option. For example, separate buttons could be provided to enable isolation of certain combinations of components such as the conveyor belt 21 (leaving braking system 21A energised), the conveyor belt 21 and its braking system 21A, the conveyor 250, or the conveyor 250 and its shuttle locking pins 250A. An operator can choose from any of these options (or an option allowing a greater level of customisation), so selecting a sub-set or sub-system of equipment items for isolation from conveyor belt system 20 as maintenance requirements dictate. Operator selection can also be made at one convenient location, whether at remote isolation station 12 or wherever the operator carrying a mobile isolation device serving as a remote isolation station is located, which saves time in the isolation procedure, thus equating to increased production. Such operator selection may be made contingent on identity verification using operator identification devices integrated with the control panel 700 as described in the Applicant's Australian Provisional Patent Application Nos. 2015902559 and 2015902564 filed on 30 Jun. 2015, the contents of which are incorporated herein by way of reference. A smart device identification system could be implemented using a card reader located at the control panel 700. Operator identification data would be stored on a smart card or other smart device following a conventional process and such data could include isolation permits to select a configurable isolation mode and work accordingly. Where a number of operators are involved, the control panel 700 (or a corresponding mobile isolation device) may present different task buttons dependent on their authority as reflected in isolation permit(s) data stored on the smart card.

Such a “configurable” isolation mode alleviates the need for an isolation officer to attend and selectively isolate the plant components which require to be worked on. It should also be noted that the configurable isolation mode may also be implemented at the CCR 40 or at other locations in the plant as required which may provide further efficiencies.

### Conditional Isolation Mode

In addition, remote isolation system 10 is advantageously configured to in certain circumstances implement a conditional isolation of conveyor belt 21, for example, following detection of tramp metal by a tramp metal detector 21B (as shown in FIG. 1). No operator intervention is required to conditionally isolate the conveyor belt 21 and the plant control system 260 simply de-energises the head pulley drive motor 22 upon detection of such tramp metal by the tramp metal detector 21B. Isolation lockout is then done in a similar manner to that described above for other isolation modes. This scenario is depicted in very simple terms with reference to FIG. 5.

By way of this “conditional” mode of isolation, the plant will be isolated automatically without the need for an initial operator request. In this way, when the operator arrives at the remote isolation station 12, 14, the isolators are already isolated saving racking time. Unlike a standard isolation mode, the conditional isolation mode does not require approval by the CRO 42 at the CCR 40 as it is a given that the specific condition presented is pre-approved for isolation.

It should also be understood that conditional isolation may be applied to other equipment and/or fault conditions occurring within the conveyor belt system 20.

### Sequential Isolation Mode

In a sequential isolation mode, the control system 260 may allow for a number of options which could also be displayed for the operator on screen 710. For ease of understanding, it may be assumed that for safety reasons, the conveyor belts 21 and 210 are to be isolated first followed by isolation of their respective braking systems 21A and 210A following energy dissipation actions to enable a subsequent safe working environments.

To select this isolation mode, the operator presses button 714 on screen 1265 of HMI 710 of remote isolation station 12 as shown in FIG. 3. The control system 260 may monitor equipment operating conditions so that isolation of each equipment item proceeds only when safe to do so. For example, conveyor belt 21 may not be isolated until zero motion is detected by a belt standstill monitor (BSM) or belt movement sensor 210B for conveyor belt 21 as described in the Applicant's Australian Provisional Patent Application Nos. 2015902554 and 2015902565. Conveyor brake systems 21A and 210A may not be isolated until a stored energy test shows that the conveyor belts 21 and 210 are indeed de-energised.

A sequential isolation mode may then involve energising some equipment items whilst the isolation proceeds. For example, the operation of belt clamps to hold a conveyor belt in position is described in the Applicants Australian Provisional Patent Application No. 2015902565 which is incorporated herein by way of reference. Accordingly, as associated conveyor belts 21 and 210 and their respective braking systems 21A and 210A are sequentially isolated, respective belt clamps may be energised as required. By way of such a “sequential” isolation mode, certain events or actions are made to occur in a specific order for the isolation to be effective.

### Inclusive Isolation Mode

In an inclusive isolation mode, the associated conveyor belts 21 and 210 are intended to be isolated following a single operator-initiated isolation request at control panel 700 of remote isolation station 12 when approved by control system 260. This mode accelerates the isolation process by avoiding the need for separate isolation requests logged at a minimum of two remote isolation stations for each of the conveyor belts 21 and 210 and potentially reduces the number of personnel and potentially the number of remote isolation stations 12, 14 involved in the isolation process.

This inclusive isolation mode requires the operator to press button 713 on screen 1265 of HMI 710 of remote isolation station 12 as shown in FIG. 3. The operator may initiate such a request not only at remote isolation station 12 or remote isolation station 14 but at any remote isolation station provided for either of conveyors 21 or 210.

By way of this “inclusive” mode of operation, the conveyor belt 21 being worked on and the upstream conveyor belt 210A are isolated. Both conveyors need to be isolated for this type of work and this isolation can be effected and locked out at the one remote isolation station 12, 14.

It should hence be evident that the remote isolation system of the present invention advantageously enables a wide range of isolation scenarios to be addressed with advantages ensuing in respect of each of the isolation modes able to be selected. Such advantages invariably include significant savings in respect of operator time and optimised plant production, and enable different/tailored modes of isolation to be implemented to suit specific applications and circumstances.

Modifications and variations to the remote isolation system described in this specification may be apparent to the skilled reader of this disclosure. Such modifications and variations are deemed within the scope of the present invention. For example, it will be understood that the remote isolation system does not need to make all the above described isolation modes available. Nor is the remote isolation system confined to use in material handling plants or plants including conveyor systems. For example, the invention may equally have applicability to process plants within facilities such as refineries or coal washing plants.

Furthermore, while the control panel 700 has primarily been described as including a Human Machine Interface (HMI) 710 with a touch screen 1265 and a series of buttons and lights (e.g. 740, 750, 760, 770, 780 etc) to enable an operator to request an isolation event, it should be noted that the control panel 700, and specifically the touch screen 1265, may be configured to provide greater control and more information about isolation system steps to an operator (or indeed full control and all information to do with the isolation system). That is, a more ‘digitally’ based input means (or indeed a totally digital system) may be arranged for operation instead of an analogue or part analogue system as described herein to enable control of the equipment isolation system according to the present invention.

1. A remote isolation system for a plant comprising:
a plurality of equipment items energisable by an energy source;
a control system enabling automatic isolation of each equipment item of said plurality of equipment items from said energy source to an isolated state when authorised by the control system,
wherein said control system is configured to respond to an isolation demand input corresponding with one of a plurality of available equipment isolation modes, each of which enable automatic isolation of at least one of said plurality of equipment items from said energy source when authorised by the control system.

2. A remote isolation system as claimed in claim 1 wherein said plurality of available isolation modes includes an isolation mode to enable isolation of an equipment item on receiving an isolation demand input in the form of a permissible isolation request from an operator.

3. A remote isolation system as claimed in claim 1 wherein said plurality of available isolation modes includes an isolation mode to isolate an equipment item whilst leaving other equipment items in said plurality of equipment items either operating or in an operational state.

4. A remote isolation system as claimed in claim 3 wherein said isolation demand input is a permissible operator request.

5. A remote isolation system as claimed in claim 1 wherein said plurality of available isolation modes includes an isolation mode to isolate said plurality of equipment items being a selected sub-set of equipment items from a set of equipment items which together comprise a plant or plant system.

6. A remote isolation system as claimed in claim 5 wherein the isolation demand input is provided by a selecting means for selecting said sub-set of equipment items for isolation.

7. A remote isolation system as claimed in claim 6 wherein said selecting means enables said sub-set of equipment items to be isolated while leaving other equipment items operating.

8. A remote isolation system as claimed in claim 7 wherein a plant comprises sub-systems of equipment items which are duplicated or operate in parallel and said selected isolation mode enables maintenance to be conducted on a sub-set of equipment whilst operation of a further parallel sub-system of equipment items enables the plant to remain in a production state.

9. A remote isolation system as claimed in claim 1 wherein said plurality of available isolation modes includes an isolation mode to isolate an equipment item without requiring an operator request.

10. A remote isolation system as claimed in claim 9 wherein said control system automatically isolates said equipment item when a sensed fault condition, being said isolation demand input, is detected.

11. A remote isolation system as claimed in claim 1 said plurality of available isolation modes includes an isolation mode to isolate associated equipment items are isolated in a specific sequence.

12. A remote isolation system as claimed in claim 1 comprising continued monitoring of the equipment items, for example through sensors, so that equipment is not flagged as isolated until monitoring confirms that this is the case.

13. A remote isolation system as claimed in claim 1 wherein said plurality of available isolation modes includes an isolation mode to isolate a plurality of associated equipment items by a single isolation demand input in the form of an operator request.

14. A remote isolation system as claimed in claim 1 including one or a plurality of remote isolation stations for selected equipment to be isolated, each said remote isolation station being in communication with the control system to enable isolation on permissible request and being provided with a control panel having an input means for issuing an isolation demand input requesting a desired isolation mode option from the plurality of available isolation modes configured for the particular remote isolation system.

15. A remote isolation system as claimed in claim 14 comprising a plurality of remote isolation stations, each remote isolation station being configured with the same plurality of available isolation modes.

16. A remote Isolation system as claimed in claim 14 comprising a plurality of remote isolation stations, each remote isolation station being configured with a different plurality of available isolation modes.

17. A remote isolation system as claimed in claim 14 wherein said control panel is configured to only enable isolation system operation following operator identity verification using an operator identification device integrated with the control panel or remote isolation system.

18. A remote isolation system as claimed in claim 17 wherein said operator identity verification includes verification of operator identification data, such as isolation permit data enabling an operator to select particular isolation modes and work in particular areas.

19. A remote isolation system as claimed in claim 17 wherein said control panel displays different isolation modes for different operators according to their operator identification data.

20. A remote isolation system as claimed in claim 14 wherein each said remote isolation station is a mobile isolation device.

21. A remote isolation system for a plant comprising:
at least one equipment item energisable by an energy source; and
a control system enabling automatic isolation of said equipment item of said plurality of equipment items from said energy source to an isolated state,
wherein said control system automatically isolates said at least one equipment item from said energy source when an equipment item operating condition as monitored by the control system requires equipment isolation.

22. A remote isolation system as claimed in claim 20 wherein said operating condition is a fault detected through monitoring of an operating condition of the equipment item.
